(19) United States
(12) Patent Application Publication
(10) Pub. No.: US 2018/0346294 A1
(43) Pub. Date: Dec. 6, 2018

(54) METHOD AND APPARATUS FOR LOAD HANDLING

(71) Applicant: VERSATILE NATURES LTD., Taoz (IL)

(72) Inventors: Dan SHELY, Petachia (IL); Ran OREN, Taoz (IL); Meirav OREN, Taoz (IL)

(21) Appl. No.: 15/607,897

(22) Filed: May 30, 2017

(51) Int. Cl. B66C 23/90; B66C 13/16; B66C 13/40; B66C 13/46

(52) U.S. Cl. CPC B66C 23/905; B66C 13/46; B66C 13/40; B66C 13/16

(57) ABSTRACT

A load handling processing (LHP) module for handling a transport of a load within a region includes a housing attachable to a crane, the housing includes: one or more sensors, configured to collect load identification data; a memory configured to store predetermined load parameters; and a processor configured to identify a load to be transported by the crane by comparing the load identification data, received from said one or a plurality of sensors, with the predetermined load parameters in the memory, to monitor a motion of the load with a load motion data during transport of the load from an initial point to a destination point in accordance with the predetermined load parameters, and to initiate corrective actions in the motion of the load if upon assessing from the monitored motion data that the load motion during transport does not conform to the predefined load parameters.

### FIELD OF THE INVENTION

The present invention relates to a load handling, and particularly to a method and apparatus for load handling.

### BACKGROUND OF THE INVENTION

In the future, it is expected that many people may not have proper housing due to housing shortages, particularly in cities, and housing will need to be erected quickly in order to ease the housing shortages. Construction projects at construction sites typically depend heavily on human capabilities, which are typically behind schedule and budget with sub-standard safety. Crane utilization may be a critical key in the success of the construction project. Proper load handling management of the crane is a core, repeated activity through the span of construction projects. If load handling is not managed properly, and the crane is not efficiently utilized, the project at a construction site may not be finished within time and budget. If load handling is unsafe, e.g., an uncontrollably swinging load due to high winds, for example, workers and by-standers may get hurt, and nearby buildings and/or structures under-construction may be damaged. In the worst case, unsafe load handling may cause the crane to become unstable, fall over and/or collapse, which may cause fatal accidents for the crane operators and for people at and/or near the construction site.

Thus, it may be desirable to have methods and apparatus for efficient handling of loads by a crane at a construction site.

### SUMMARY OF THE INVENTION

There is thus provided, in accordance with some embodiments of the present invention, a load handling processing (LHP) module for handling a transport of a load within a region The LHP module may include a housing attachable to a crane, the housing including a housing attachable to a crane, the housing includes: one or a plurality of sensors, configured to collect load identification data; a memory configured to store predetermined load parameters; and a processor configured to identify a load to be transported by the crane by comparing the load identification data, received from said one or a plurality of sensors, with the predetermined load parameters in the memory, to monitor a motion of the load with a load motion data during transport of the load from an initial point to a destination point in accordance with the predetermined load parameters, and to initiate corrective actions in the motion of the load if upon assessing from the monitored motion data that the load motion during transport does not conform to the predefined load parameters.

According to some embodiments of the invention, said one or a plurality of sensors is further configured to collect environmental object identification data.

In some embodiments of the invention, said one or a plurality of sensors is further configured to the collect load motion data.

In some embodiments, the predefined load parameters comprise load identifiers or a load handling specification.

In some embodiments, the load handling specification specifies criteria for safe load handling or efficient load handling.

In some embodiments, the LHP module is further configured to communicate with a base station.

In some embodiments, the communication module is configured to relay the collected load identification raw data and load motion raw data to the base station.

In some embodiments, the one or a plurality of sensors are selected from the group consisting of a GPS device, a wind gauge, a video camera, a laser, a weight scale, a radio frequency identification reader, an ultrasound sensor, a proximity sensor, a barometer, an accelerometer, a motion sensor, an inertial measurement unit, a rotation motion sensor, a sound detector, a humidity sensor, and a temperature sensor.

In some embodiments, there is provided a method for handling a transport of a load within a region. The method may include using a processor, identifying a load to be transported by a crane by comparing load identification data, received from one or a plurality of sensors configured to collect load identification data and load motion data, with predetermined load parameters stored in a memory in the LHP module.

The method may also include using the one or a plurality of sensors, monitoring a motion of the load with the load motion data during transport of the load from an initial point to a destination point in accordance with the predetermined load parameters

The method may further include, if upon assessing from the monitored motion data that the load motion during transport does not conform to the predefined load parameters, initiating corrective actions to the load motion.

In some embodiments, the predefined load parameters comprise load identifiers or a load handling specification.

In some embodiments, the load identifiers are selected form the group consisting of a load serial number, a load parameter, a load name, a load dimension, a load use, a load velocity limit, a load leveling parameter, and a load maximum tilt angle.

In some embodiments, monitoring the motion of the load comprises establishing a plurality of virtual safety spheres around the load.

In some embodiments, assessing that the motion of the load does not conform to the load handling specification comprises detecting that an object entered within the plurality of virtual safety spheres around the load.

In some embodiments, initiating the corrective actions comprises sending alerts to a crane operator or to the LHP module, or sending a request to automatically move the crane or the load into a safe position.

In some embodiments, there is provided a system for handling a transport of a load The system may include at least one load handling processing (LHP) module attachable to at least one crane, the at least one LHP module including at least one base station comprising a base station processor and a base station memory, the at least one base station configured to communicate with at least one LHP module; one or a plurality of sensors configured to collect load identification data and load motion data; one or a plurality of sensors configured to collect load identification data and load motion data; one or a plurality of memories configured to store predetermined load parameters; and one or a plurality of processors configured to identify a load to be transported by the at least one crane by comparing load identification data, received from the plurality of sensors, with the predetermined load parameters in the LHP module memory, to monitor a motion of the load with the load motion data during transport of the load from an initial point to a destination point in accordance with the predetermined load parameters, and to initiate corrective actions in the motion of the load if upon assessing from the monitored motion data that the load motion during transport does not conform to the predefined load parameters.

In some embodiments, said one or a plurality of processors are located in the base, and are configured to receive the load identification raw data and the load motion raw data from the at least one LHP module.

In some embodiments, the predefined load parameters of the at least one LHP module comprise criteria for safe load handling, and wherein a processor of said one or a plurality of processors located in the at least one LHP module or a processor of said one or a plurality of processors located in the at least one base station are configured to assess if the load motion during transport by the at least one crane is unsafe when the load identification data and the load motion data does not conform to the criteria for safe load handling.

In some embodiments, the processor of said one or a plurality of processors located in the at least one LHP module or the processor of said one or a plurality of processors located in the at least one base station are configured to initiate corrective actions in the load motion of the at least one crane by sending a request to a crane operator to move the at least one crane or the load transported by the at least one crane to a safe position.

In some embodiments, the system also includes a remote server including a server processor and a server memory, the remote server configured to communicate over a communication network with the at least one base station or the at least one LHP modules attachable to the at least one crane at multiple construction sites.

In some embodiments, the server processor is configured to receive the load identification data and the load motion data from the at least one LHP module or at least one base station processor, and to assess from the received load identification data and the load motion data from the at least one modules if the load motion of the at least one crane does not conform to the predefined load parameters stored in the memory of the at least one LHP module.

In some embodiments, the server processor is configured to control operational processes at the multiple construction sites.

In some embodiments, the server processor is configured to control the operational processes by using modules executed by the server processor selected from the group consisting of a load handling process monitoring module, inventory control and load recognition module, a resource monitoring module, a deep learning module and optimizer module, and an Environment, Health and Safety (EHS) module.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1A schematically illustrates a system for load handling in a region with a crane, in accordance with some embodiments of the present invention;

FIG. 1B illustrates an operator cab of a crane, according to some embodiments of the present invention.

FIG. 1C illustrates a load handling processing (LHP) module at the distal end of cable 44 of crane 20, according to some embodiments of the present invention.

FIG. 1D illustrates a base station, according to some embodiments of the invention.

FIG. 2 schematically illustrates a block diagram of a LHP module, in accordance with some embodiments of the present invention;

FIG. 3 schematically illustrates a block diagram of a base station (BS), in accordance with some embodiments of the present invention;

FIG. 4 schematically illustrates a top level diagram of a system for load handling controlling operational processes at multiple construction sites, in accordance with some embodiments of the present invention;

FIG. 5 schematically illustrates a plurality of virtual safety spheres around a handled load, in accordance with some embodiments of the present invention;

FIG. 6A schematically illustrates a tilt in a load suspended on a tethering rope from a crane hook, in accordance with some embodiments of the present invention;

FIG. 6B schematically illustrates a load positioned flush along a surface after being lowered, in accordance with some embodiments of the present invention;

FIG. 7 shows a graph illustrating measured load weight detected using a weight scale versus time, in accordance with some embodiments of the present invention;

FIG. 8 illustrates a method for handling of a load by a load handling processing (LHP) module, in accordance with some embodiments of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Some embodiments of the present invention herein relate to a multi-sensor, load handling processing module that is configured to be attached (attachable) to a hook of a crane (crane hook). Typically, the crane may be located at a construction site, but it may also be located another place where the transport of heavy loads may be needed, such as containers on a ship at a wharf or heavy load in a factory, for example. The crane typically lifts a load at an initial point and transports it to a destination point. The load handling processing module is configured to collect information from a plurality of sensors in the module so as to monitor the transport.

A system for load handling may include a crane transporting a load in a single construction site, for example, where the load handling processing module communicates with a base station. The base station located on the crane or elsewhere in the construction site, for example, may be fully integrated with the load handling processing module and may be used to collect data on the crane or any other place on the construction site. The base station may be used to coordinate construction activities in real time at the construction site. The system may further include a remote server, such as a cloud server, at a remote site whose processing unit may be configured to control operational processes at multiple construction sites and to control the transport of a load of at least one crane via at least one load handling processing module and at least one base station at the multiple constructions sites. The remote server may be located at the headquarters of a construction company, for example.

A crane operator sitting in the cab of the crane may have a console in front of him to prompt him on various metrics related to the load in transport, as the crane operator manipulates the boom of the crane supporting the hoist rope, which is attached to the crane hook that holds the load. For stability of the crane, the sum of the moments about the base of the crane must be close to zero, otherwise the crane may lose stability. The crane may thus tip, overturn, and/or collapse damaging nearby structures and/or buildings. This may also injure or kill people near to the collapse site as well as the crane operator.

The system for load handling may be configured to assess if the load motion and/or the position of the load does not conform to predefined load parameters such as load identifiers and/or load handling specifications such as safety specifications. The system for load handling may assess in real time if the load motion, for example, will destabilize the crane. The system for load handling may send alerts such as warnings to the crane operator to change the position of the load and/or to move the load to the ground, for example. The system for load handling may also assess if the identified load are being transported by a crane efficiently so as to minimize the construction costs and time of a building project, for example.

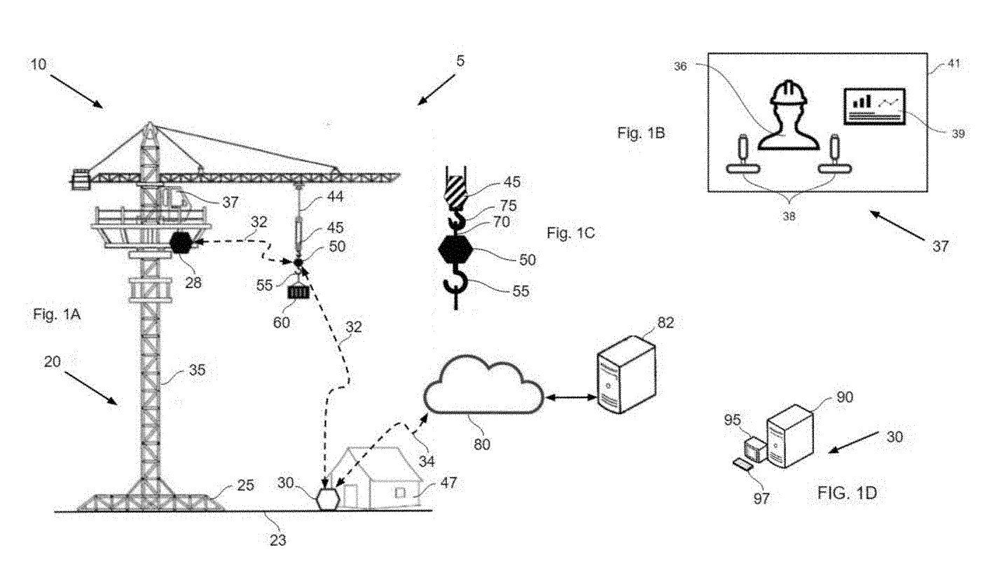

FIG. 1 schematically illustrates a system 5 for load handling in a region 10 with a crane 20, in accordance with some embodiments of the present invention. Region 10 in the context herein may also mean any area, such as at a wharf, factory, or a construction site, for example, where heavy loads may be transported from one location to another location within region 10 by crane 20. The terms region and construction site may be used interchangeably herein, but the embodiments of the present invention are not limited to a construction site.

Crane 20 may include a vertical boom 35 attached to a base 25 positioned on a surface 23, such as the ground, and horizontal boom 40. A hoist rope 45 may be attached to horizontal boom 40. A load handling processing (LHP) module 50 may be attached to hoist rope 45 at one end and to a crane hook 55 along the bottom side of load handling processing module 50. Crane hook 55 may be attached to a load 60 for transport from an initial point to a destination point within region 10 such that load 50 may be tethered by hoist rope 45.

FIG. 1C illustrates LHP module 50 at the distal end of cable 44 of crane 20, according to some embodiments of the present invention. LHP module 50 may include a ring 70 attached to the top side of the housing of LHP module 50 and crane hook 55 attached to the bottom side of the body of LHP module 50. In this case, the housing of LHP module 50 supports the weight of the load. Nevertheless, LHP module 50 may be attachable to crane hook 55 in any suitable configuration to monitor load handling and the region around load 60.

FIG. 1B illustrates an operator cab of a crane, according to some embodiments of the present invention. A crane operator 36 may operate crane 20 from an operator cab 37 mounted on vertical boom 35 of crane 20. Crane operator 36 as shown in enlargement 41 may operate crane 20 using controls 38. A crane operator monitor 39 (e.g., display) may provide status reports, navigational information, and/or alerts to crane operator 36 regarding the transport of load 60 from point-to-point in region 10. In some embodiments, crane operator monitor 39 may also include a keyboard (not shown) for crane operator 36 to manually input data. A base station 28 may be mounted on vertical boom 35 to communicate 32 with LHP module 50.

Crane 20 is shown in FIG. 1 as a tower crane, which is not by way of limitation of the embodiments of the present invention. Crane 20 may be selected from the group of fixed cranes consisting of a tower crane, a self-erecting tower crane, a telescopic crane, a hammerhead crane, a level luffing crane, a gantry crane, a deck crane, a jib crane, a bulk-handling crane, a loader crane, and a stacker crane. Crane 20 may also be selected from the group of mobile cranes consisting of an overhead crane, a truck-mounted crane, a sidelifter crane, a rough terrain crane, an all-terrain crane, a pick and carry crane, a carry deck crane, a telescopic handler crane, a harbor crane, a railroad crane, a floating crane, and an aerial crane. Operator cab 37 may be positioned at any suitable location such as on the crane as in FIG. 1, next to, or below the crane.

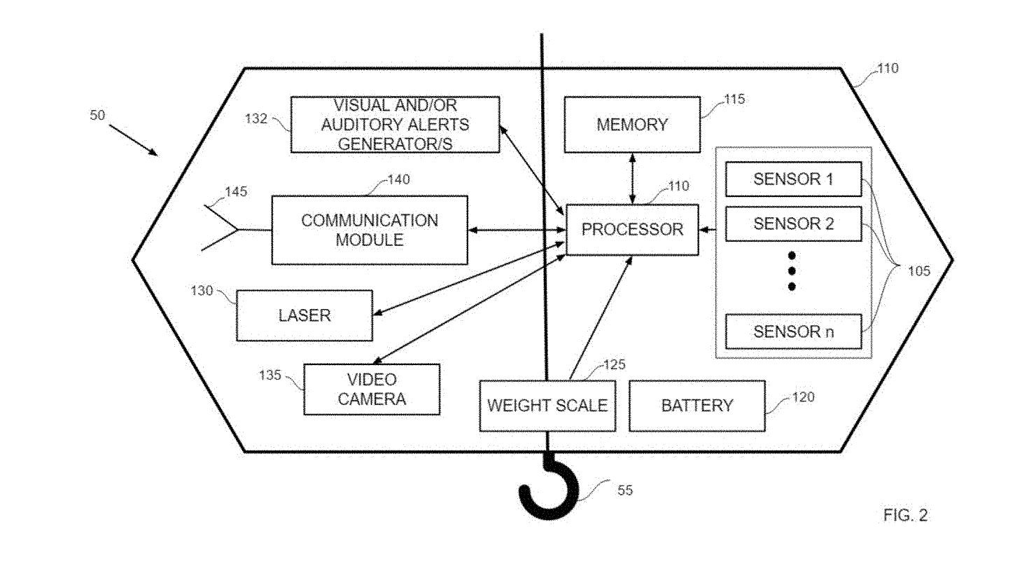

In some embodiments of the present invention, LHP module 50 may communicate 32 with a base station 30 located in region 10 at an on-site office 47, for example. Base station 30 and base station 28 are configured to communicate with LHP module 50, and may be located at any location in region 10. The base stations may receive updates periodically or in real time about load handling, the position of load in region 10 and relative to crane 20, load specification (e.g., weight, dimensions, category, etc.), conditions (e.g., tilt, leveling, bending, acceleration, legal accessory load, etc.), position of the crane, relative position with respect to other cranes and other landmarks, condition of the crane (e.g., height, tilt, leveling, prescribed work area and borders, acceleration, etc.) so as to monitor load transport from an initial point to a destination point in region 10. Base stations 28 and 30 may receive position data for example from any suitable GPS system and/or satellite (not shown in FIG. 1). LHP module may also process images acquired by a sensor or sensors, for example, imaging sensor (e.g., 135 in FIG. 2) to identify and predict environmental conditions. For example, identifying workers not wearing safety accessories (e.g., helmet, vest), identifying existence of unlawful or banned tools, identifying weather conditions, water leakage, smoke, material damage, etc. wind, rain, dusk, humidity, temperature, etc.

Base stations 28 and/or 30 may be configured to communicate with and receive data 34 from a remote server 82, for example, via a communication network such as the internet 80 (e.g., cloud computing network). Remote server 82 may be located at a different location from region 10. Remote server 82 may control the activities and resource management across multiple construction sites and may be located, for example, at the headquarters of a construction company.

FIG. 1D illustrates a base station 30, according to some embodiments of the invention. Base station 30 at on-site office 47 may include a base station (BS) server 90, an output device 95 (e.g., terminal or screen) for displaying information, and an input device 97, such as a keyboard for inputting data to BS server 90.

FIG. 2 schematically illustrates a block diagram of load handling processing (LHP) module 50, in accordance with some embodiments of the present invention. LHP module 50 may include a housing 100 on which crane hook 55 may be attached to housing 100. In some embodiments, a ring 70 may also be attached to housing 100 (not shown in FIG. 2). Ring 70 may be configured, for example, to be attached to hook 75, and hook 75 may be configured to be attached to hoist rope 45. Nevertheless, any combination of ring 70 and crane hook 55 may be formed into housing 100. In this case, shown in FIG. 2, housing 100 may be formed from materials selected from polymers, metals or a combination thereof. In other embodiments, LHP module 50 may be configured to be attachable to crane hook 55 such as to be held by a brace and/or bracket attachable to crane hook 55 for coupling crane hook 55 to hoist rope 45. In this case, housing 100 may not need to withstand the weight of load 60.

LHP module 50 may include circuitry including a processor 110 coupled to a memory 115, and a communication module 140 for relaying data, such as collected load identification data and load motion data, between LHP module 50 and the base stations via an antenna 145. LHP module 50 receives data inputs regarding load handing from a plurality of n sensors 105 (e.g., SENSOR 1, SENSOR 2, . . . SENSOR n), where n is an integer, such as load motion data and load identification data. LHP module 50 may also receive data inputs regarding load handing of load 60 from additional sensors such as image data from a video camera 135, proximity data from a laser 130 (e.g., a laser transmitting laser beams and receiving reflections, and/or other electromagnetic (EM) or sound waves generator, such as, for example ultrasound generator) and a weight scale 125 for measuring and monitoring the weight of load 60 suspended from crane hook 55. The load handing data received from the plurality of sensors may be processed and analyzed by program code stored in memory 115 and executed by processor 110. The term plurality of sensors may also refer to video camera 135, laser 130, and weight scale 125. The load handling data may include a load handling specification, which may also specify criteria for safe load handling or efficient load handling.

In some embodiments, LHP module 50 may include a visual and/or auditory alert generator 132, which may be configured to send out an audible signal alert and/or a visual alert to people in region 10 near crane hook 55 regarding safety issues in the transport of load 60 (e.g., an unstably tethered load that may fall and injure people, for example). Alert generator 132 may be configured to alert people in the region that the motion of load is unsafe.

Since LHP module 50 (e.g., housing 100) is attachable to crane hook 55 while hanging by hoist rope 45, LHP module 50 may be powered by a battery 120, such as a rechargeable battery. As a result, in order to enhance battery life during the day and to minimize the need to recharge or replace battery 120 during the daily activities of the construction site, the power consumption of LHP module 50 may be minimized by off-loading the processing of the data from the plurality of n sensors to the base stations 28 and/or 30 and/or remote server 82. This may be performed wirelessly by relaying the collected load handling data from the plurality of sensors 105, video camera 135, laser 130 and weight scale 125 via communication module 140 to base station 28 (e.g. on the crane), base station 30 (e.g., in region 10), and/or remote server 82 for processing. Likewise, base station 28, base station 30, and/or remote server 82 may relay instructions to crane operator 36 via crane operator monitor 39, and/or directly to LHP module 50. In some embodiments, the communication between LHP module 50, base station 28, base station 30, and/or remote server 82 may be bi-directional.

In some embodiments of the present invention, load handling processing (LHP) module 50 for handling a transport of a load within a region may include housing 100 attachable to crane 30. Housing 100 may include plurality of sensors 105 configured to collect load identification data and load motion data. Memory 115 may be configured to store predetermined load parameters. Processor 110 may be configured to identify a load to be transported by the crane by comparing load identification data, received from the plurality of sensors, with the predetermined load parameters in the memory, to monitor a motion of the load with the load motion data during transport of the load from an initial point to a destination point in accordance with the predetermined load parameters, and to initiate corrective actions in the motion of the load if upon assessing from the monitored motion data that the load motion during transport does not conform to the predefined load parameters.

The predefined load parameters may be preloaded and stored in memory 115. The may be uploaded to processor 110 via communication module 145 from the base stations and/or from remote server 82, and stored in memory 155. The predefined load parameters may include load identifiers and/or load handling specifications. The load handling specifications may include specific criteria for safe load handling (e.g., safety specifications) and/or efficient load handling to reduce cost and increase the efficiency of the construction project, for example.

Although the plurality of sensors 105, video camera 125, laser 130, and weight scale 125 are shown in the block diagram in LHP module 50 as being inside housing 100, any of the plurality of sensors 105 may be positioned and/or located anywhere inside the LHP module or attached outside the LHP module near to or onto housing 100. The plurality of sensors 105 may include:

1. A GPS device—for position detection using a GPS receiver for assessing the exact location of LHP module 50 in region 10 for load handling management. A GPS device may be configured to relay the data to processor 110 and memory 115 using standard protocols. The GPS device provides positioning resolution of at least +/−1 cm with sampling frequencies of more than 10 Hz, for example. In some embodiments, base station 28 may be configured to use the GPS data from the GPS receiver in LHP module 50 to identify the reference center point for all positional measurements.

2. Wind gauge—raw wind gauge (anemometer) readings may be configured to relay the data to processor 110 and memory 115. In some embodiments, the anemometer may provide wind speed reading with a resolution of 0.5 meters/sec, 1 deg resolution, and a sampling frequency larger than 1 Hz, for example.

3. Crane weight scale (e.g. weight scale 125) to provide real time measurements of the weight of load 60. In some embodiments, the crane weight scale may have a sampling frequency larger than 5 Hz with 1 kg weight resolution. Weight scale 125 may be configured to relay the data to processor 110 and memory 115. Weight scale 125 may include a built-in sensor health detector on demand to access weight measurement accuracy.

4. Video camera 135 mounted on housing 100—configured to acquire raw image data on demand by receiving a request from processor 110. Video camera 135 may include compression algorithms to compress the acquired image streams using any suitable still and/or video stream formats (e.g., JPEG, PNG, MPEG, etc.). Video camera 135 may be configured to relay the data to processor 110 and memory 115.

5. Radio frequency identification (RFID) reader—Active and/or passive RFID tags may be used throughout different objects in region 10. For example, an RFID tag may be fixed to load 60 so as to assist in identifying load 60 as LHP module 50 on crane hook 55 approach the vicinity of the load and the RFIC reader may receive the data stored on the RFID tag to assist in load recognition. The RFID reader may be configured to relay the data to processor 110 and memory 115.

6. Ultrasound sensor—ultrasound waves may be useful for range detection between LHP module 50 and objects in region 10. Ultrasound may also be used to detect the contour of load 60 for use in load handling safety assessments. The ultrasound sensor may be configured to relay the data, such as the reflected ultrasound waves, to processor 110 and memory 115.

7. Proximity sensor—may be used to detect the presence of nearby objects to LHP module 50 without any physical contact for preventing collision of load 60 with nearby objects. A proximity sensor may emit electromagnetic radiation (infrared, for instance), and measure the fields reflected to the sensor. A capacitive or photoelectric sensor may be used for detecting the proximity to a plastic load. An inductive proximity sensor may be used to detect a metal load. Proximity sensor may be configured to relay the proximity data to processor 110 and memory 115.

8. Barometer—a barometer may be used to measure the height of LHP module 50 above sea level. In some embodiments, the barometer may have a sampling frequency of 10 Hz and a height resolution of 0.1 meter. The same or an additional barometer in LHP module 50 may also be used to measure the air pressure. In some embodiments, the barometer sensor used for air pressure detection may include a 10 Hz sampling frequency with a barometric pressure accuracy of 0.02 hPa. The barometer here may be configured to relay the height data to processor 110 and memory 115.

9. Accelerometer and/or motion sensors—are used to measure the motion and vibrations on load 60. Sensors in this class may include, for example, displacement sensors, potentiometers, linear variable differential transformer (LVDT), Strain Gauges, Extensometers, Load Cells, and Piezo-Electric Sensors. Each of the accelerometer and/or motion sensors may be configured to relay the height data to processor 110 and memory 115. In some embodiments, the accelerometers may have a sampling frequency of greater than 25 Hz and a sensitivity of 0.002 grams.

10. Inertial Measurement Unit (IMU)—an IMU may be used to measure the heading and speed of LHP module 50. In some embodiments, the IMU may have a sampling frequency of greater than 10 Hz with a magnetometer resolution of less than 1.5 mgaus and a gyro resolution of less than 0.02 deg/sec. The IMU may be configured to relay the height data to processor 110 and memory 115.

11. Rotational motion sensors—rotational motion sensors, such as magneto-resistive rotational speed sensors, for example, may be used to measure angular motion such as angular displacement, angular velocity, and angular acceleration data. This may be used to measure the swing angle of load 60 during transport as well as the curl angle of load 60. In some embodiments, the rotational motion sensors may have a sampling frequency of greater than 10 Hz and a 0.5% resolution. The rotational motion sensors may be configured to relay the angular motion data to processor 110 and memory 115.

12. Sound detectors—In some embodiments, the sound detectors may have with a sampling frequency of greater than 10 Hz. The sound detectors may be configured to relay the detected sound data to processor 110 and memory 115. Sound detectors may be used (e.g., by applying machine learning techniques, or using recorded noise data for comparison) to identify regular operational sounds and detect abnormal sounds (for example to monitor site-related noises in order to determine whether regulations are met, e.g., during on/off shi [symbol] period; crane-related mechanical conditions, etc.)

13. Humidity sensor—humidity sensors may be used to detect the humidity in region 10 particularly around LHP module 50. In some embodiments, the humidity sensor may have a sampling frequency of 1/60 Hz, a humidity resolution of 0.1% over a 0-100% range. The humidity sensor may be configured to relay humidity data to processor 110 and memory 115.

14. Temperature sensor—temperature sensors such as thermocouples, resistance thermometer, integrated circuit sensors, and silicon bandgap temperature sensors, for example, may be used to provide the temperature of load 60 as well as the ambient temperature external to load 60. The temperature sensor may be configured to relay temperature data to processor 110 and memory 115.

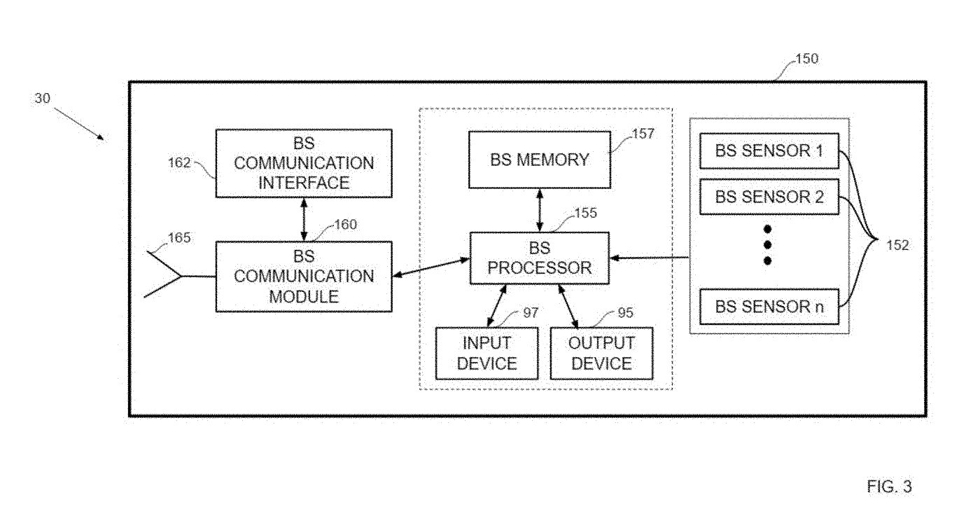

FIG. 3 schematically illustrates a block diagram of base station (BS) 30, in accordance with some embodiments of the present invention. BS 30 may include a server 90 further including a base station processor 155, a BS memory 157, input device 97 and output device 95. Base station 30 may also include a BS communication module 160 configured to communicate wirelessly via a BS antenna 165 with LHP module 50 and/or with remote server 82. In other embodiments, BS communication module 160 may be configured to communicate over a wired connection with remote server 82 over the internet 80 via a BS communication interface 162. Note that some or all of the elements in the block diagram of FIG. 3 may be also applicable to base station 28 positioned on vertical crane boom 35. Some or all of the elements in the block diagram of FIG. 3 of base station 30 may be enclosed in a BS housing 150.

Base station 30 receives data inputs regarding a variety of parameters in region 10 from a plurality of m sensors 152 (e.g., SENSOR 1, SENSOR 2, . . . SENSOR m), where m is an integer. Although the plurality of sensors 152 are shown in the block diagram of base station 30 as inside BS housing 150, any of sensors 152 may be positioned and/or located anywhere inside base station 30 or attached outside base station 30 to BS housing 150. The plurality of sensors 152 may include:

1. Barometer—A barometer coupled to base station 30 may also be used to measure the air pressure in region 10. In some embodiments, the barometer sensor used for air pressure detection may include a 10 Hz sampling frequency with an barometric pressure accuracy of 0.02 hPa. The barometer may be configured to relay the barometric pressure data to processor 155 and memory 157.

2. A GPS device—for position detection using a GPS receiver for assessing the exact location of base station 30 in region 10 for load handling management. A GPS device may be configured to relay the data to processor 155 and memory 157 using standard protocols. In some embodiments, the GPS device may provide positioning resolution of at least +/−1 cm with sampling frequencies of more than 10 Hz, for example.

Other base station sensors may include, for example, wind gauge, spirit level sensor, rotation sensor, audio sensor, accelerometer, etc.

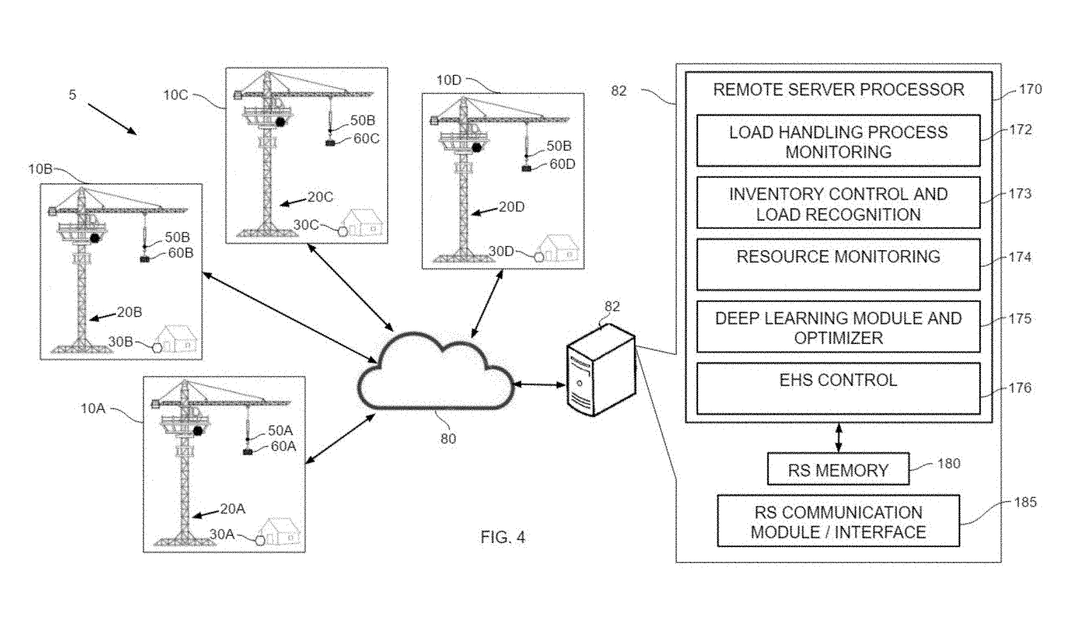

FIG. 4 schematically illustrates a top level diagram of system 5 for load handling controlling operational processes at multiple construction sites, in accordance with some embodiments of the present invention. Each of regions 10A . . . 10D may respectively include cranes 20A, . . . 20 D transporting loads 60A . . . 60D, base stations 28A . . . 28D and 30A . . . 30D, and LHP modules 50A . . . 50D. Operation processes of four construction sites 10A, 10B, 10C, and 10D may be digitalized and may be controlled by remote server 82 via the internet 80. Four construction sites are shown merely for visual clarity and not be way of limitation of the embodiments of the present invention. One or any number of construction sites may be managed by remote server 82. Each of base stations 28A . . . 28D and 30A . . . 30D may be configured to receive load handling information from LHP modules 50A . . . 50D and to relay that information to remote server 82.

In some embodiments of the present invention, remote server 82 may, for example, manage inventory between multiple construction sites. Remote server 82 may monitor weather reports and send alerts to the multiple construction sites. Remote server may use deep learning for load recognition by sharing the load data acquired between the multiple constructions sites.

In some embodiments of the present invention, remote server 82 may be configured to receive data inputs from each of base stations 28A . . . 28D and 30A . . . 30D, and to process and relay outputs and commands back to base stations 28A . . . 28D and 30A . . . 30D. In some embodiments, the data may include a suppliers, inputs, process, outputs, and customers (SIPOC) approach so as to summarize the inputs and outputs of one or more of the operational processes in a tabular format.

In some embodiments of the present invention, remote server (RS) 82 may include a RS processor 170, a RS memory 180, and a RS communication module and interface unit 185 for communicating with base stations 28A . . . 28D and 30A . . . 30D over the internet 80.

Some embodiments of the present invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

Each of processors 110, 155, and 175 may include one or more processing units, e.g. of one or more computers. Processors 110, 155, and 175 may be configured to operate in accordance with programmed instructions stored in respective memories 115, 157, and 180. Processors 110, 155, and 175 may be capable of executing an application for controlling the operational processes of construction site operations in multiple regions as described herein.

Processor 155 may communicate with output device 95. For example, output device 95 may include a computer monitor or screen. Processor 155 may communicate with a screen of output device 95 to display load handling status reports, alerts and construction site operational details. In another example, output device 95 may include a printer, display panel, speaker, or another device capable of producing visible, audible, or tactile output.

Processor 155 may communicate with input device 97. For example, input device 97 may include one or more of a keyboard, keypad, or pointing device for enabling a user to inputting data or instructions for operation of processor 155.

Processor 155 may communicate with memory 157. Memory 157 may include one or more volatile or nonvolatile memory devices. Memory 157 may be utilized to store, for example, programmed instructions for operation of processor 155 data or parameters for use by processor 155 during operation, or results of operation of processor 155. In some embodiments, RS processor 170 may communicate with any suitable input and/or output device similarly as shown for BS processor 155.

Some of the software modules when executed by RS processor 170 may include a load handling process monitor module 172, an inventory control and load recognition module 173, a resource monitoring module 174, a deep learning module and optimizer module 175, and an Environment, Health and Safety module (EHS) 176. Although not shown in FIG. 3, BS processor 155 may also execute these modules locally on each processor 155 in each of base stations 28A . . . 28D and 30A . . . 30D.

In some embodiments of the present invention, although not shown in FIG. 3, one or more of the modules 172-176 may also be stored in BS memory 157 and executed by BS processor 155 in base station 28 and/or 30 in region 10, that is, modules 172-176 may be executed locally at base stations at a specific construction site 10A . . . 10D, instead of remote server 80.

Each of cranes 20A . . . 20D may move each of respective loads 60A . . . 60D from an initial point to a destination point. The following processes may occur, for example, in each case. With reference to FIG. 1, the crane operator of first crane 20 may move crane hook 55 to an initial point where load 60 is waiting. A worker, such as a site coordinator, for example, may band load 60 to crane hook 55. Crane 20 may then move load 60 from the initial point to the destination point. Load 60 may then be released. During this process, LHP module 50 may be monitoring the transport of load 60 and reporting the status of load 60 to base station 28 and/or base station 30. These base stations may subsequently relay the status report to central RS server 82.

In some embodiments of the present invention, load 60 may be recognized using inventory control and load recognition module 173. RS server 82 via base station 28 and/or 30 may indicate the location of load 60 to be transported to crane operator 36 on operator terminal 39. Moreover, load 60 may include RFID tags, for example, or other indicia may be attached to the load for load identification. As crane hook 55 and LHP module 50 approach load 60, one or more of the plurality of sensors 105 such as an RFID reader, or image data acquired by video camera 125 subsequently processed by processor 110, for example, may be used to identify load 60 so as to ensure that the intended load will be transported by crane hook 55.

In some embodiments, load identifiers such as characteristics and indicia for load recognition may include the serial number, part number, name of the load as well as the physical characteristics of load 60, which may include the use of the load, dimensions, velocity limits for transport, load leveling, and maximum load tilt angles that may be attached to each load type. With the algorithms used by load recognition module 173, not only the object may be recognized, but actions may be performed to improve load handling efficiency.

In some embodiments of the present invention, processor 110 in LHP module 50 may receive a request from Inventory Control and Load Recognition module 173 to recognize a load type. Not every load 60 may have an assigned ID, so validation may be required. If load 60 passes validation, LHP module 50 may transmit the load ID which may be recognized within Inventory Control and Load Recognition module 173 by applying load recognition algorithms using the load ID.

In some embodiments, where load 60 may not be validated, more advanced load recognition data from sensors in LHP module 50 may be acquired. For example, video camera 125 may be used to acquire image data of load 60 taken from video camera 125. Load 60 may be scanned with ultrasound. Load 60 may be thermally scanned. All of this acquired data may be relayed to Inventory Control and Load Recognition module 173.

If no load is recognized, LHP module 50 may notify Inventory Control and Load Recognition module 173. Processor 170 may then implement resource monitoring module 174, and deep learning module and optimizer module 175 to decide how to proceed in the event that load 60 is not recognized and validated.

In some embodiments, load recognition and identification may be performed based on RFID scanning. If RFID scanning is unsuccessful in recognizing load 60, other recognition methods with other sensors in LHP module 50 may be used. The most effective stage in load recognition is when crane hook 55 travels to the desired load for identification. Video camera 125 may capture and acquire image data which is then relayed to inventory control and load recognition module 173.

If RFID and image data recognition methods fail to identify the load, other sensors 105 may be used to attempt to identify load 60. This data may be relayed to resource monitoring 174 and deep learning 175 modules, and then compared to previously stored reference data on data structures and patterns of the loads to assist in load recognition. Mathematic analysis may be used, for example, for load identification and matching the RFID data and/or image data to stored references data.

In some embodiments, as crane hook 55 and LHP module 50 approach the desired load, data from multiple sensors 105 may be acquired and transmitted to base station 28 and/or 30 for recognition. For example, the iron pallets may exhibit a distinct thermal color due to heat, sound wave signature, unique image data patterns and an ultrasound map that are distinctly different from other types of loads. Reference data for iron-based pallets may be stored in RS memory 180, for example, and referenced by inventory control and load recognition module 173.

Also during load identification and verification of load 60, additional data may be relayed to base station 30 and crane operator 36 such load weight, permissible load transport parameters, such as allowed acceleration, velocity, and load motions for a given load type, for example. These parameters may be useful for identifying safety aspects of the load transport, as well as assisting in fully identifying the load, since the load may also exhibit unique behavior during handling and transport. The load behavior may also be correlated to aspects such load velocity, wind conditions, weight, etc. Modules 172-176 operating on RS processor 170 on RS server 82 may use these parameters to account for these effects.

In some embodiments, if all of these techniques fail in identifying the load, manual recognition by a person in region 10, such as a construction site coordinator, for example, may be used to identify the load. During manual recognition, data from both LHP module 50 and data manually added by the construction site coordinator may be uploaded to machine learning module 175 as load reference data. This load reference data may used by load recognition module 173 for real time comparison of the acquired load recognition data by the plurality of sensors to the load reference data stored in BS memory 157, RS memory 180, and/or memory 115 in LHP module 50 for load identification.

In some embodiments of the present invention, load handling process monitor module 172 may include functions which manage the transport of loads 60A . . . 60D across multiple regions 10A . . . 10D (e.g., across multiple construction sites). LHP modules 50A . . . 50D may relay the load handling information during the transport of loads 60A . . . .60D to the respective base stations 28A . . . 28D and 30A . . . 30D and to RS server 82. Once load 60 is identified, the load may be banded, attached to crane hook 55, and transported from the initial point in region 10 to a destination point in region 10. At the destination point, load 60 may be then lowered and un-banded. LHP module 50 and/or crane operator 36 may then relay an acknowledgement to base stations 28 and/or 30 that the transport of load 60 has been completed. RS server 82, upon receiving the acknowledgement from base stations 28 and/or 30, may update the database associated, for example, with resource monitoring module 174 that load 60 had been delivered to the proper destination.

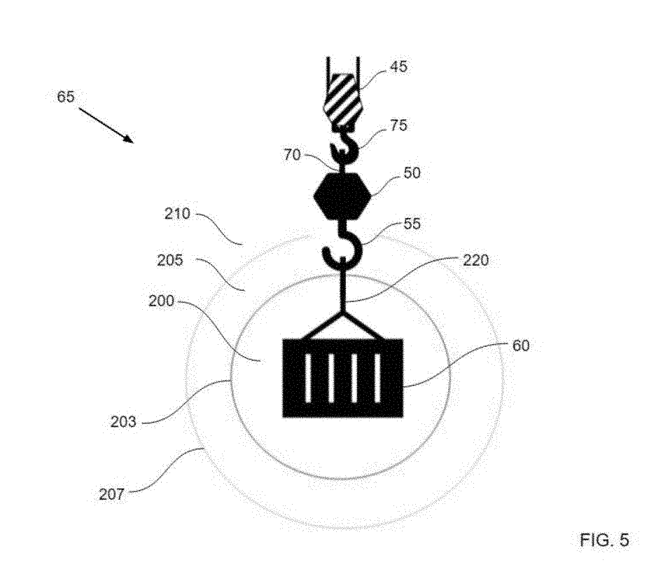

FIG. 5 schematically illustrates a plurality of virtual safety spheres 203 and 207 around a handled load, in accordance with some embodiments of the present invention. During the transport of load 60 from the initial point to the destination point, LHP module 50 is configured to access whether the transport of load 60 may stay within safety parameters set forth in EHS control module 176, which may be used to correlate a load type with load handling and safety specifications for the given load type. LHP module 50 may monitor the motion data. Using the plurality of sensors 105 to detect the motion data and safety data uploaded to memory 115, LHP module 50 may be configured to establish plurality of virtual safety spheres 203 and 207 around load 60 as shown in FIG. 5 according to the load handling specification so as to monitor the motion of the load during transport.

In some embodiments of the present invention, a critical area 200 may be defined from load 60 to the edge of virtual safety sphere 203. A warning area 205 may be defined from the edge of virtual safety sphere 203 to the edge of virtual safety sphere 207. A safe area 210 may be defined as any region outside of virtual safety sphere 207. The size of the virtual safety spheres may be determined by the safety specification for a particular load type stored in a database on remote server 82. The size of the virtual safety spheres may be uploaded to memory 115 in LHP module 50 before the transport of load 60.

During the transport of load 60, any objects that come in proximity to load 60 in region 10 by entering warning area 205 and/or critical area 200 will trigger collision warning alerts by LHP module 50. The alerts may be sent to base stations 28 and/or 30, and to RS server 82 to request instructions to initiate corrective actions. In other embodiments, if a collision is imminent, LHP module 50 may be configured to initiate corrective actions automatically on-the-fly.

In some embodiments of the present invention, assessing that the motion of the load does not conform to the load handling specification may include detecting that an object entered with the plurality of virtual safety spheres around the load.

In other embodiments, LHP module 50 may assess other safety metrics within the virtual safety spheres that are not limited to collision avoidance during load transport, but even when the crane may be not in motion, but in steady state (e.g., at rest). For example, LHP module 50 and/or base station 28 and/or base station 30 may assess weather conditions within the safety spheres during the night given the load weight, size, and position on the crane to determine if the crane's state meets safety criteria. For example, strong winds may cause the crane to collapse so LHP module 50 and/or base stations 28 and/or 30 and/or RS server 82 may initiate actions to prevent a crane collapse. Even if there is no load attached to crane hook 55, strong winds may cause crane hook 55 to fly around in region 10 perhaps damaging other structures in region 10. LHP module 50 in detecting this condition may be configured to automatically lower the crane hook 55 to the ground, or to fully retract hoist rope 45 to prevent crane hook 55 from flying around, for example.

Using virtual safety spheres around load 60 enables LHP module 50 and base stations 28 and/or 30 to assess the quality of air, temperature, humidity, etc. about load 60 in these spheres. In some embodiments, more spheres may be added and used by LHP module 50 to define different safety criteria about load 60. Any number of virtual virtual safety spheres around load 60 may be used.

When crane hook 55 is in motion to receive load 60, virtual safety spheres 203 and 207 may be used by LHP module 50 to control crane hook 55. Raw data for processing by load handling process monitoring module 172 may be acquired by the plurality of sensors 105 and by the plurality of BS sensors 152. To use virtual safety spheres 203 around crane hook 55 may include using ongoing range detection between load 60 and other objects. EHS control module 176 may define virtual safety spheres 203 for a known load 60 based on the geometry of LHP module 50. EHS control module 176 running on RS server 82 and/or on BS server 90 may be used to accurately calculate, the real range between load 60 and objects in region 10. In some cases, algorithms used in EHS control module 176 may apply extrapolation from the geometry of LHP module 50 to calculate the real range between load 60 and nearby objects, such as crane components, for example.

In some embodiments, virtual safety spheres 203 may be used to detect the height of the load from the ground. For example, if load 60 is tilted, swinging, and/or accelerating in an unwanted direction, points on the tilted load may contact the ground in the wrong position, for example, upon lowering the load. LHP module 50 may be sending transport data from motion and position sensors to the base stations and/or RS server 82 to compare the transport data with safety data to determine if transport to the destination point is unsafe according to the load handling safety specification.

In some embodiments of the present invention, the plurality of sensors 105 in LHP module 50 and/or the plurality of BS sensors 152 may detect undesirable and/or unsafe states in the load handling and/or progress of the construction to trigger a variety of alerts as described in Table I below related to load handling safety and/or load handling efficiency. These alerts of undesirable and/or unsafe states may be relayed to the crane operator, and/or relayed to the BS server 90 and/or RS server 82.

TABLE I
List of alerts that can be sent to the crane operator and the RS server
for system level processing based on real time assessments.

| Alert Description | Category |
|---|---|
| Load Falls | Safety |
| Accessory disconnection | Safety |
| (e.g., LHP module) | |
| Load may fall | Safety |
| Load swinging | Safety |
| Misuse of the recommend loading guidelines | Safety |
| Load leveling | Safety |
| Load tilting | Safety |
| Risk of load collision with static objects | Safety |
| Risks of crane-to-crane collision | Safety |
| Unacceptable objects on load | Safety |
| If morning safety tests have not been done | Safety |
| If hook is not in position at end of day | Safety |
| If load safety pin is not released at wind conditions | Safety |
| Load handling process gaps - time | Efficiency |
| Load handling process gaps - unnecessary number of people | Efficiency |
| Load handling process gaps - cycle time | Efficiency |
| Non-valuable load handling | Efficiency |
| Crane idle time | Efficiency |
| Crane idle with load | Efficiency |
| Overall and continuous hours of operation of crane | Safety |
| Crane operation in bad weather conditions | Safety |
| Controlling and alerting regarding off-loading from truck | Efficiency |
| Maintain operations with adjustments to wind factors | Efficiency |
| Illegal load - load under-weight | Efficiency |
| Crane's tower angle - non-standard position | Safety |
| Crane usage to re-organize operational level | Efficiency |
| Irregular load discharge to prevent damage to the load and | Safety |
| crane | |
| “Spaghetti model” - analysis of crane and load movements | Safety |
| between ground and floors | |
| Cement rate as efficiency tool - Dynamic change in load | Efficiency |
| weight (Overall duration) | |

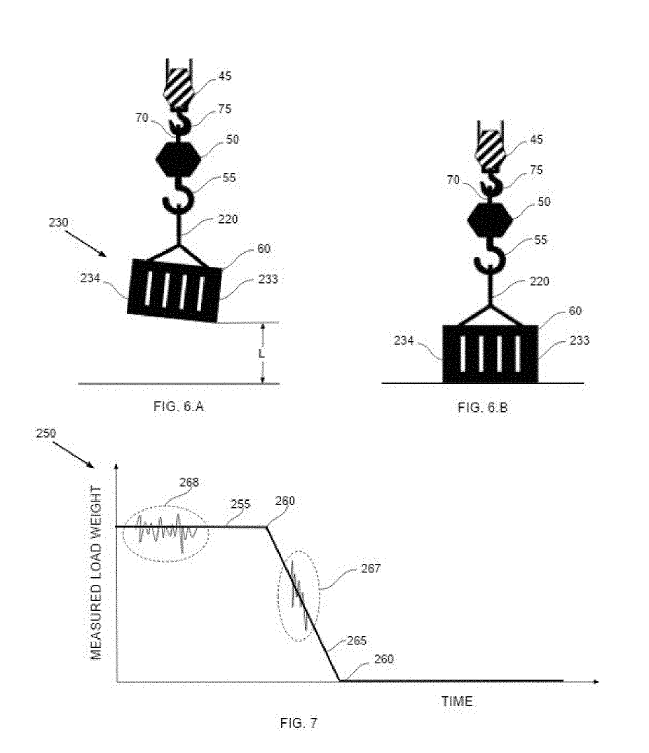

FIG. 6A schematically illustrates a tilt 230 in load 60 suspended on a tethering rope 220 from crane hook 55, in accordance with some embodiments of the present invention. Due to tilt 230, a right side 234 of load 60 with a height L above a surface 232 will contact surface 232 before left side of 233 of load 60. This tilted state is an unsafe state for load handling.

FIG. 6B schematically illustrates load 60 positioned flush along surface 232 after being lowered, in accordance with some embodiments of the present invention.

FIG. 7 shows a graph 250 illustrating measured load weight detected using weight scale 125 versus time, in accordance with some embodiments of the present invention. Along a first portion 255 of graph 250, weight scale 125 measures the full weight of load 60 as shown in FIG. 6A as load 60 is being lower toward surface 232. As the corner along right edge touches the ground, the detected weight at point 260 starts to decrease along line 265 as more of load 60 contacts the ground. Finally at point 270 of graph 250, the load is sitting flush along ground 232. If there were no tilt 230 in load 60, line 265 in FIG. 7 would have a nearly vertical slope. FIG. 7 illustrates how a tilted load may be detected.

In some embodiments, other anomalies in the transport of load 60 may be detected from graph 250. For example, while load 60 is still suspended, ripples 268 in the curve may indicate that load 60 may be vibrating, shaking and/or swaying, for example, in the wind. Alternatively, a peak 267 during the lowering of load 60 may indicate that the process of lowering load 60 may not be normal. These anomalies may be detected in real time, for example, and processed by base station server 90 and/or by remote server 82.

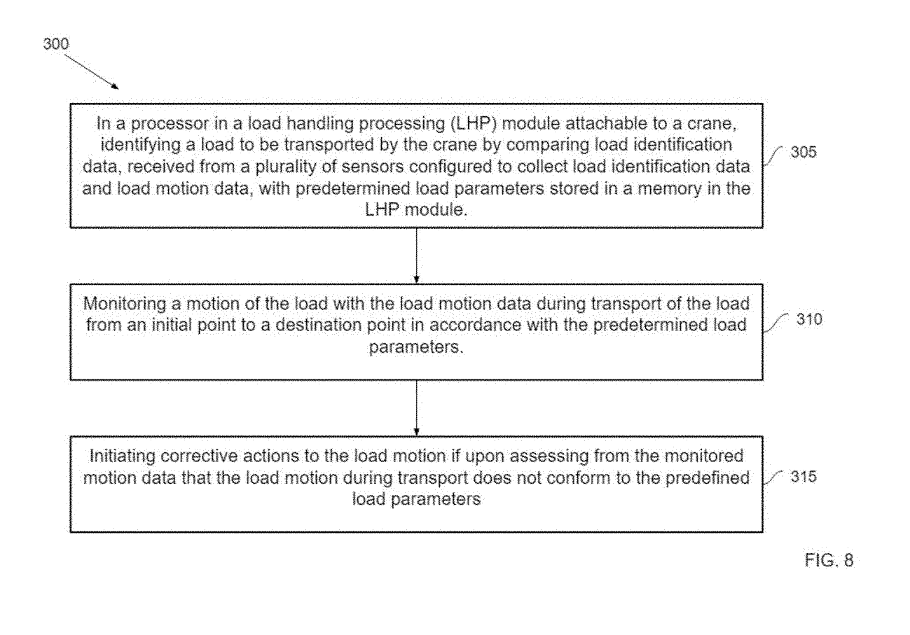

FIG. 8 illustrates a method for handling of a load by a load handling processing (LHP) module, in accordance with some embodiments of the present invention.

Method 300 includes in a processor in a load handling processing (LHP) module attachable to a crane, identifying 305 a load to be transported by the crane by comparing load identification data, received from a plurality of sensors configured to collect load identification data and load motion data, with predetermined load parameters stored in a memory in the LHP module.

Method 300 includes monitoring 310 a motion of the load with the load motion data during transport of the load from an initial point to a destination point in accordance with the predetermined load parameters.

Method 300 includes if, upon assessing from the monitored motion data, that the load motion during transport does not conform to the predefined load parameters, initiating 315 corrective actions to the load motion.

In some embodiments of the present invention, initiating 320 corrective actions to the load motion may include sending alerts (e.g., as in Table I) to the crane operator or to the LHP module to automatically move the crane (e.g., to ensure crane stability) and/or the crane hook and/or the load tethered to the crane hook so as to move the load into a safe position.

In some embodiments of the present invention (referring to FIGS. 1 and 4), system 5 for handling a transport of a load may include at least one load handling processing (LHP) module (50A . . . 50D) and at least one base station (28A . . . 28D, 30A . . . 30D). The at least one load handling processing (LHP) module (50A . . . 50D) attachable to at least one crane may include a plurality of sensors configured to collect load identification data and load motion data, an LHP module memory configured to store predetermined load parameters, and an LHP module processor. The at least one base station may include a base station processor and a base station memory. The at least one base station may be configured to communicate with the at least one LHP module.

In some embodiments of the present invention, the base station processor of the at least one base station may be configured The LHP processor may be configured to identify a load (60A . . . 60D) to be transported by the at least one crane by comparing load identification data, received from the plurality of sensors, with the predetermined load parameters in the LHP module memory, to monitor a motion of the load with the load motion data during transport of the load from an initial point to a destination point in accordance with the predetermined load parameters, and to initiate corrective actions in the motion of the load if upon assessing from the monitored motion data that the load motion during transport does not conform to the predefined load parameters.

In some embodiments of the present invention, the predefined load parameters of the at least one LHP module may include criteria for safe load handling, and the processor of the at least one LHP module or the base station processor of the at least one base station may be configured to assess if the load motion during transport by the at least one crane is unsafe when the load identification data and the load motion data does not conform to the criteria for safe load handling.

In some embodiments of the present invention, the processor of the at least one LHP module or the base station processor of the at least one base station may be configured to initiate corrective actions in the load motion of the at least one crane by sending a request to a crane operator to move the at least one crane or the load transported by the at least one crane to a safe position.

In some embodiments of the present invention, system 5 may further include remote server 82 including server processor 170 and server memory 180, the remote server configured to communicate over a communication network with the at least one base station or the at least one LHP modules attachable to the at least one crane at multiple construction sites (10A . . . 10D).

In some embodiments of the present invention, the server processor may be configured to receive the load identification data and the load motion data from the at least one LHP module, and to assess from the received load identification data and the load motion data from the at least one modules if the load motion of the at least one crane does not conform to the predefined load parameters stored in the memory of the at least one LHP module.

In some embodiments of the present invention, the server processor may be configured to control operational processes at the multiple construction sites.

In some embodiments of the present invention, the server processor may be configured to control the operational processes by using modules executed by the server processor selected from the group consisting of a load handling process monitoring module, inventory control and load recognition module, a resource monitoring module, a deep learning module and optimizer module, and an Environment, Health and Safety (EHS) module.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A load handling processing (LHP) module for handling a transport of a load within a region, the LHP module comprising:
a housing attachable to a crane, the housing includes:
one or a plurality of sensors, configured to collect load identification data;
a memory configured to store predetermined load parameters; and
a processor configured to identify a load to be transported by the crane by comparing the load identification data, received from said one or a plurality of sensors, with the predetermined load parameters in the memory, to monitor a motion of the load with a load motion data during transport of the load from an initial point to a destination point in accordance with the predetermined load parameters, and to initiate corrective actions in the motion of the load if upon assessing from the monitored motion data that the load motion during transport does not conform to the predefined load parameters.

2. The LHP module according to claim 1, wherein said one or a plurality of sensors is further configured to collect environmental object identification data.

3. The LHP module according to claim 1, wherein said one or a plurality of sensors is further configured to the collect load motion data.

4. The LHP module according to claim 1, wherein the predefined load parameters comprise load identifiers or a load handling specification.

5. The LHP module according to claim 4, wherein the load handling specification specifies criteria for safe load handling or efficient load handling.

6. The LHP module according to claim 1, further configured to communicate with a base station.

7. The LHP module according to claim 6, wherein the communication module is configured to relay the collected load identification raw data and load motion raw data to the base station.

8. The LHP module according to claim 1, wherein the one or a plurality of sensors are selected from the group consisting of a GPS device, a wind gauge, a video camera, a laser, a weight scale, a radio frequency identification reader, an ultrasound sensor, a proximity sensor, a barometer, an accelerometer, a motion sensor, an inertial measurement unit, a rotation motion sensor, a sound detector, a humidity sensor, and a temperature sensor.

9. A method for handling a transport of a load within a region, the method comprising:
using a processor, identifying a load to be transported by a crane by comparing load identification data, received from one or a plurality of sensors configured to collect load identification data and load motion data, with predetermined load parameters stored in a memory in the LHP module;
using the one or a plurality of sensors, monitoring a motion of the load with the load motion data during transport of the load from an initial point to a destination point in accordance with the predetermined load parameters; and
if, upon assessing from the monitored motion data, that the load motion during transport does not conform to the predefined load parameters, initiating corrective actions to the load motion.

10. The method according to claim 9, wherein the predefined load parameters comprise load identifiers or a load handling specification.

11. The method according to claim 10, wherein the load identifiers are selected form the group consisting of a load serial number, a load parameter, a load name, a load dimension, a load use, a load velocity limit, a load leveling parameter, and a load maximum tilt angle.

12. The method according to claim 9, wherein monitoring the motion of the load comprises establishing a plurality of virtual safety spheres around the load.

13. The method according to claim 12, wherein assessing that the motion of the load does not conform to the load handling specification comprises detecting that an object entered within the plurality of virtual safety spheres around the load.

14. The method according to claim 9, wherein initiating the corrective actions comprises sending alerts to a crane operator or to the LHP module, or sending a request to automatically move the crane or the load into a safe position.

15. A system for handling a transport of a load, the system comprising:
at least one load handling processing (LHP) module attachable to at least one crane, the at least one LHP module including:
at least one base station comprising a base station processor and a base station memory, the at least one base station configured to communicate with at least one LHP module
one or a plurality of sensors configured to collect load identification data and load motion data;
one or a plurality of memories configured to store predetermined load parameters; and
one or a plurality of processors configured to identify a load to be transported by the at least one crane by comparing load identification data, received from the plurality of sensors, with the predetermined load parameters in the LHP module memory, to monitor a motion of the load with the load motion data during transport of the load from an initial point to a destination point in accordance with the predetermined load parameters, and to initiate corrective actions in the motion of the load if upon assessing from the monitored motion data that the load motion during transport does not conform to the predefined load parameters.

16. The system according to claim 15, wherein said one or a plurality of processors is located in the base, and is configured to receive the load identification raw data and the load motion raw data from the at least one LHP module.

17. The system according to claim 16, wherein the predefined load parameters of the at least one LHP module comprise criteria for safe load handling, and wherein a processor of said one or a plurality of processors located in the at least one LHP module or a processor of said one or a plurality of processors located in the at least one base station are configured to assess if the load motion during transport by the at least one crane is unsafe when the load identification data and the load motion data does not conform to the criteria for safe load handling.

18. The system according to claim 17, wherein the processor of said one or a plurality of processors located in the at least one LHP module or the processor of said one or a plurality of processors located in the at least one base station are configured to initiate corrective actions in the load motion of the at least one crane by sending a request to a crane operator to move the at least one crane or the load transported by the at least one crane to a safe position.

19. The system according to claim 15, further comprising a remote server including a server processor and a server memory, the remote server configured to communicate over a communication network with the at least one base station or the at least one LHP modules attachable to the at least one crane at multiple construction sites.

20. The system according to claim 19, wherein the server processor is configured to receive the load identification data and the load motion data from the at least one LHP module or at least one base station processor, and to assess from the received load identification data and the load motion data from the at least one modules if the load motion of the at least one crane does not conform to the predefined load parameters stored in the memory of the at least one LHP module.

21. The system according to claim 19, wherein the server processor is configured to control operational processes at the multiple construction sites.

22. The system according to claim 21, wherein the server processor is configured to control the operational processes by using modules executed by the server processor selected from the group consisting of a load handling process monitoring module, inventory control and load recognition module, a resource monitoring module, a deep learning module and optimizer module, and an Environment, Health and Safety (EHS) module.
